(19) United States
(12) Patent Application Publication
(10) Pub. No.: US 2026/0175135 A1
(43) Pub. Date: Jun. 25, 2026

(54) Game Interaction Method and Apparatus, Device, and Computer-Readable Storage Medium

(71) Applicant: Tencent Technology (Shenzhen) Company Limited, Shenzhen (CN)

(72) Inventor: Ying DENG, Shenzhen (CN)

(73) Assignee: Tencent Technology (Shenzhen) Company Limited, Shenzhen (CN)

(21) Appl. No.: 19/448,927

(22) Filed: Jan. 14, 2026

Related U.S. Application Data
(63) Continuation of application No. PCT/CN2024/112612, filed on Aug. 16, 2024.

(30) Foreign Application Priority Data
Nov. 7, 2023 (CN) 202311478672.9

(51) Int. Cl. A63F 13/847; A63F 13/424; A63F 13/533; A63F 13/56

(52) U.S. Cl. CPC A63F 13/847; A63F 13/424; A63F 13/533; A63F 13/56

(57) ABSTRACT

A game interaction method includes: displaying a game picture, the game picture including a first virtual object and a second virtual object located in a virtual environment; displaying, in response to a trigger operation of a cooperative function, action identifiers of at least one candidate cooperative action; and transmitting, in response to a trigger operation on an action identifier of a first cooperative action among the at least one candidate cooperative action, a first cooperation request including first voiceprint information to a second terminal device corresponding to the second virtual object, the first cooperation request being configured for providing cooperation content corresponding to the first cooperative action for the first virtual object by the second terminal device based on the first voiceprint information. The game interaction becomes more diverse and flexible, and the human-computer interaction rate is improved.

### RELATED APPLICATION

The present disclosure is a continuation of and claims the benefit of priority to PCT Application No. PCT/CN2024/112612, filed Aug. 16, 2024, and entitled GAME INTERACTION METHOD AND APPARATUS, DEVICE AND COMPUTER-READABLE STORAGE MEDIUM, which is based on and claims the benefit of priority to Chinese Patent Application No. 202311478672.9, filed on Nov. 7, 2023 and entitled “GAME INTERACTION METHOD AND APPARATUS, DEVICE, AND COMPUTER-READABLE STORAGE MEDIUM.” The above applications are incorporated herein by reference in their entireties.

### FIELD OF THE TECHNOLOGY

Embodiments of the present disclosure relate to the technical field of computers, and in particular, to a game interaction method and apparatus, a device, and a computer-readable storage medium.

### BACKGROUND OF THE DISCLOSURE

With the continuous development of computer technologies and game technologies, games have taken up an increasingly significant proportion in people's daily lives, becoming an indispensable part of leisure and entertainment. People's demands for the diversity, flexibility, and interaction rate of game interaction are increasingly growing. Therefore, it is necessary to provide a game interaction method to improve the diversity, flexibility, and interaction rate of game interaction.

### SUMMARY

Embodiments of the present disclosure provide a game interaction method and apparatus, a device, and a computer-readable storage medium, to improve the diversity, flexibility, and interaction rate of game interaction. Technical solutions are as follows.

According to an aspect, an embodiment of the present disclosure provides a game interaction method, which is performed by a first terminal device and includes the following operations:
displaying a game picture, the game picture including a first virtual object and a second virtual object located in a virtual environment;
displaying, in response to a trigger operation of a cooperative function, action identifiers of at least one candidate cooperative action; and
transmitting, in response to a trigger operation on an action identifier of a first cooperative action among the at least one candidate cooperative action, a first cooperation request including first voiceprint information to a second terminal device corresponding to the second virtual object, the first cooperation request being configured for providing cooperation content corresponding to the first cooperative action for the first virtual object by the second terminal device based on the first voiceprint information, and the first voiceprint information being determined based on the action identifier of the first cooperative action.

An embodiment of the present disclosure further provides a game interaction method, which is performed by a second terminal device and includes the following operations:
receiving a first cooperation request, the first cooperation request including first voiceprint information, the first voiceprint information being determined based on an action identifier of a first cooperative action, and the first cooperation request being configured for providing cooperation content corresponding to the first cooperative action for a first virtual object; and
providing the cooperation content corresponding to the first cooperative action for the first virtual object based on the first voiceprint information.

According to another aspect, an embodiment of the present disclosure provides a game interaction apparatus, including:
a display module, configured to display a game picture, the game picture including a first virtual object and a second virtual object located in a virtual environment;
the display module being further configured to display, in response to a trigger operation of a cooperative function, action identifiers of at least one candidate cooperative action; and
a transmitting module, configured to transmit, in response to a trigger operation on an action identifier of a first cooperative action among the at least one candidate cooperative action, a first cooperation request including first voiceprint information to a second terminal device corresponding to the second virtual object, the first cooperation request being configured for providing cooperation content corresponding to the first cooperative action for the first virtual object by the second terminal device based on the first voiceprint information, and the first voiceprint information being determined based on the action identifier of the first cooperative action.

An embodiment of the present disclosure further provides a game interaction apparatus, including:
a receiving module, configured to receive a first cooperation request, the first cooperation request including first voiceprint information, the first voiceprint information being determined based on an action identifier of a first cooperative action, and the first cooperation request being configured for providing cooperation content corresponding to the first cooperative action for a first virtual object; and
a providing module, configured to provide the cooperation content corresponding to the first cooperative action for the first virtual object based on the first voiceprint information.

According to another aspect, an embodiment of the present disclosure provides a game interaction system, including a first terminal device and a second terminal device; the first terminal device being configured to perform the foregoing game interaction method performed by the first terminal device, and the second terminal device being configured to perform the foregoing game interaction method performed by the second terminal device.

According to another aspect, an embodiment of the present disclosure provides a computer device, including a processor and a memory, the memory having at least one program code stored therein, and the at least one program code being loaded and executed by the processor, to cause the computer device to implement any one of the foregoing game interaction methods.

According to another aspect, a non-volatile computer-readable storage medium is further provided, the non-volatile computer-readable storage medium having at least one program code stored therein, and the at least one program code being loaded and executed by a processor, to cause a computer to implement any one of the foregoing game interaction methods.

According to another aspect, a computer program or a computer program product is further provided, the computer program or the computer program product having at least one computer instruction stored therein, and the at least one computer instruction being loaded and executed by a processor, to cause a computer to implement any one of the foregoing game interaction methods.

In the technical solutions provided in the embodiments of the present disclosure, when the first virtual object needs help, the cooperative function is triggered to display the action identifier of the candidate cooperative action so that the action identifier of the first cooperative action is triggered in the action identifier of the candidate cooperative action, and the first cooperation request including the first voiceprint information of the first cooperative action is transmitted to the second terminal device corresponding to the second virtual object. Thus, the second virtual object timely provides the help needed by the first virtual object for the first virtual object. In this manner, timely and effective communication between two players can be achieved without voice interaction between a player controlling the first virtual object and a player controlling the second virtual object, which enriches communication manners between the two players, thereby improving the flexibility and diversity of game interaction, improving game experience of the players, and further improving a human-computer interaction rate.

### BRIEF DESCRIPTION OF THE DRAWINGS

FIG. 1 is an example schematic diagram of an implementation environment of a game interaction method according to an embodiment of the present disclosure.

FIG. 2 is an example flowchart of a game interaction method according to an embodiment of the present disclosure.

FIG. 3 is an example schematic diagram of display of a game picture according to an embodiment of the present disclosure.

FIG. 4 is an example schematic diagram of display of another game picture according to an embodiment of the present disclosure.

FIG. 5 is an example schematic diagram of display of a cooperative action selection page according to an embodiment of the present disclosure.

FIG. 6 is an example schematic diagram of display of yet another game picture according to an embodiment of the present disclosure.

FIG. 7 is an example schematic diagram of display of a target area according to an embodiment of the present disclosure.

FIG. 8 is an example schematic diagram of display of a second multimedia resource according to an embodiment of the present disclosure.

FIG. 9 is an example flowchart of another game interaction method according to an embodiment of the present disclosure.

FIG. 10 is an example flowchart of another game interaction method according to an embodiment of the present disclosure.

FIG. 11 is an example schematic structural diagram of a game interaction apparatus according to an embodiment of the present disclosure.

FIG. 12 is an example schematic structural diagram of another game interaction apparatus according to an embodiment of the present disclosure.

FIG. 13 is an example schematic structural diagram of a game interaction system according to an embodiment of the present disclosure.

FIG. 14 is an example schematic structural diagram of a terminal device according to an embodiment of the present disclosure.

FIG. 15 is an example schematic structural diagram of a server according to an embodiment of the present disclosure.

### DESCRIPTION OF EMBODIMENTS

To make the objectives, technical solutions, and advantages of the present disclosure clearer, implementations of the present disclosure will be described in further detail below with reference to the accompanying drawings.

The terms “first”, “second”, and so on in the present disclosure are intended to distinguish similar objects but do not necessarily describe a specific order or sequence. Data used in such a way may be interchanged in proper circumstances so that the embodiments of the present disclosure described herein can be implemented in other orders than the order illustrated or described herein. The implementations described in the following exemplary embodiments do not represent all implementations consistent with the present disclosure. On the contrary, the implementations are merely examples of an apparatus and a method that are consistent with some aspects of the present disclosure described in detail in claims.

First, abbreviations and key terms involved in the embodiments of the present disclosure are defined.

Virtual environment: it is an environment provided (or displayed) when an application runs on a terminal device. The virtual environment refers to an environment created for virtual objects to carry out activities. The virtual environment may be a two-dimensional virtual environment, a 2.5-dimensional virtual environment, or a three-dimensional virtual environment. The virtual environment may be a simulated environment of the real world, a semi-simulated environment of the real world, or a completely fictional environment. For example, the virtual environment involved in the embodiments of the present disclosure is a three-dimensional virtual environment.

Virtual object: it is a movable object in the virtual environment. The movable object may be a virtual character, a virtual animal, or a cartoon character. Players can control the virtual object through peripheral components or by clicking a touchscreen. Each virtual object has a shape and size in the virtual environment, and occupies some space in the virtual environment. For example, when the virtual environment is a three-dimensional virtual environment, the virtual object is a three-dimensional model created based on a skeletal animation technology.

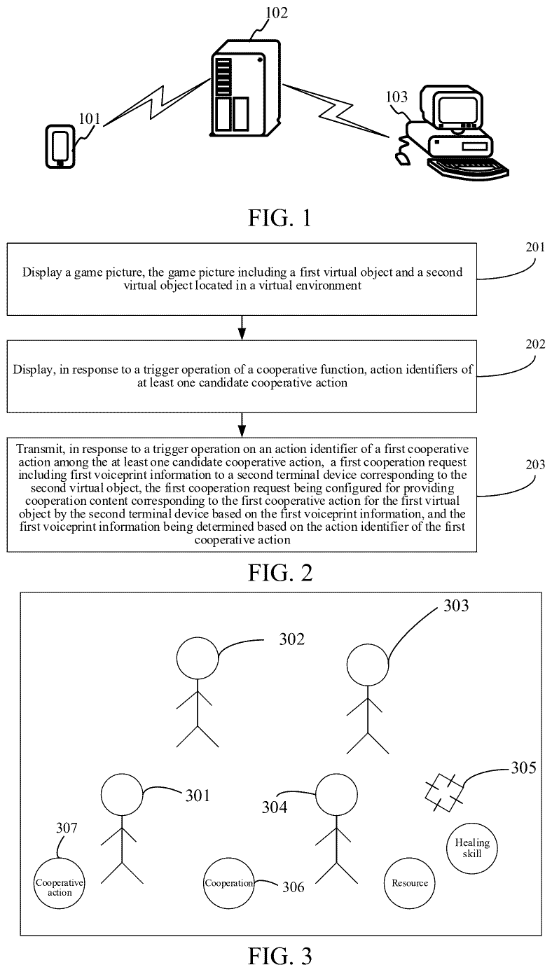

FIG. 1 is a schematic diagram of an implementation environment of a game interaction method according to an embodiment of the present disclosure. As shown in FIG. 1, the implementation environment includes a first terminal device 101, a server 102, and a second terminal device 103.

A game client that can provide a virtual environment is installed and run in the first terminal device 101, and the first terminal device 101 is a terminal device used by a first object controlling a first virtual object. A game client that can provide a virtual environment is installed and run in the second terminal device 103, and the second terminal device 103 is a terminal device used by a second object controlling a second virtual object. The game interaction method provided in this embodiment of the present disclosure is performed through the first terminal device 101, the second terminal device 103, or the interaction among the first terminal device 101, the server 102, and the second terminal device 103.

For example, the game client that can provide a virtual environment may be a third-person shooting (TPS) game, a first-person shooting (FPS) game, a multiplayer online battle arena (MOBA) game, a multiplayer shooting survival game, a massive multiplayer online (MMO) role-playing game, an action role playing game (ARPG), a virtual reality (VR) client, an augmented reality (AR) client, a three-dimensional map program, a map simulation program, a social client, and an interactive entertainment client.

The server 102 is configured to provide backend services for the game client that is installed in the first terminal device 101 (the second terminal device 103) and can provide a virtual environment. In a possible implementation, the server 102 undertakes primary computing work, and the first terminal device 101 (the second terminal device 103) undertakes secondary computing work. Alternatively, the server 102 undertakes secondary computing work, and the first terminal device 101 (the second terminal device 103) undertakes primary computing work. Alternatively, cooperative computing is performed between the first terminal device 101 (the second terminal device 103) and the server 102 using a distributed computing architecture.

In one embodiment, the first terminal device 101 and the second terminal device 103 may be respectively any electronic device product that may perform human-computer interaction with a user in one or more manners such as a keyboard, a touchpad, a remote control, voice interaction, or a handwriting device. For example, the first terminal device 101 and the second terminal device 103 may be a smartphone, a tablet computer, a notebook computer, a desktop computer, a smart speaker, a smartwatch, a personal computer (PC), a mobile phone, a personal digital assistant (PDA), a wearable device, a pocket PC (PPC), a smart on-board unit, or a smart television. In some embodiments, users can also be referred to as players or objects.

The server 102 may be one server, a server cluster formed by multiple servers, or any one of a cloud computing center or a virtualization center. This is not limited in this embodiment of the present disclosure. The server 102 is directly or indirectly connected with the first terminal device 101 and the second terminal device 103 in a wired or wireless communication mode. The server 102 has a data receiving function, a data processing function, and a data transmission function. Certainly, the server 102 can also have other functions. This is not limited in this embodiment of the present disclosure.

A person skilled in the art can understand that the terminal device terminal device 101, the second terminal device 103, and the server 102 are only examples, and other existing or future possible terminal devices or servers that are applicable to the present disclosure are also to be included in the scope of protection of the present disclosure, and are included herein by reference.

An embodiment of the present disclosure provides a game interaction method, which can be applied to the implementation environment shown in FIG. 1. By taking a flowchart of a game interaction method according to an embodiment of the present disclosure shown in FIG. 2 as an example, the method may be performed by the first terminal device 101 in FIG. 1. As shown in FIG. 2, the method includes the following operation 201 to operation 203.

In operation 201, a game picture is displayed, the game picture including a first virtual object and a second virtual object located in a virtual environment.

In an exemplary embodiment of the present disclosure, a game client that can provide a virtual environment is installed and run in the first terminal device. The game client may be a client of any game. This is not limited in this embodiment of the present disclosure. The game client may be a game client of a first-person view, or a game client of a third-person view. The game client may be a game client based on frame synchronization. That is, the game interaction method according to this embodiment of the present disclosure can be applied to the game client based on frame synchronization.

A display interface of the first terminal device displays related information of the game client. The related information of the game client may be a name of the game client, an icon of the game client, or other information that can uniquely represent the game client. The related information of the game client is not limited in this embodiment of the present disclosure. When intending to run the game client, a first object selects the related information of the game client, and the first terminal device receives a selection operation for the related information of the game client, starts the game client, and displays a home page of the game. A start control is displayed in the home page of the game and is configured for starting a round of game.

The first object is a user using the first terminal device, and an account of the first object may be logged into on the first terminal device. The first object selecting the related information of the game client may refer to the first object clicking on the related information of the game client, or the first object double-clicking on the related information of the game client. The first object may alternatively select the related information of the game client in another manner. A manner in which the first object selects the related information of the game client is not limited in this embodiment of the present disclosure.

When intending to start a round of game, the first object selects the start control, and the first terminal device starts a round of game and displays a game picture. The game picture includes a first virtual object, a second virtual object, and at least one third virtual object located in a virtual environment. The first virtual object is a virtual object controlled by the first object, the second virtual object is a virtual object controlled by the second object, and each third virtual object is a virtual object controlled by another object participating in the game. For example, the second virtual object and the first virtual object belong to the same game team, e.g., the second object controlling the second virtual object and the first object belong to the same game team. For example, the second virtual object and the first virtual object belong to different game teams, e.g., the second object controlling the second virtual object and the first object belong to different game teams.

The another object participating in the game may be an object belonging to the same game team as the first object, or an object belonging to different game teams from the first object. This is not limited in this embodiment of the present disclosure. The fact that the another object participating in the game and the first object belong to the same game team indicates that a virtual object controlled by the another object participating in the game and the first virtual object belong to the same game team. The fact that the another object participating in the game and the first object do not belong to the same game team indicates that a virtual object controlled by the another object participating in the game and the first virtual object do not belong to the same game team.

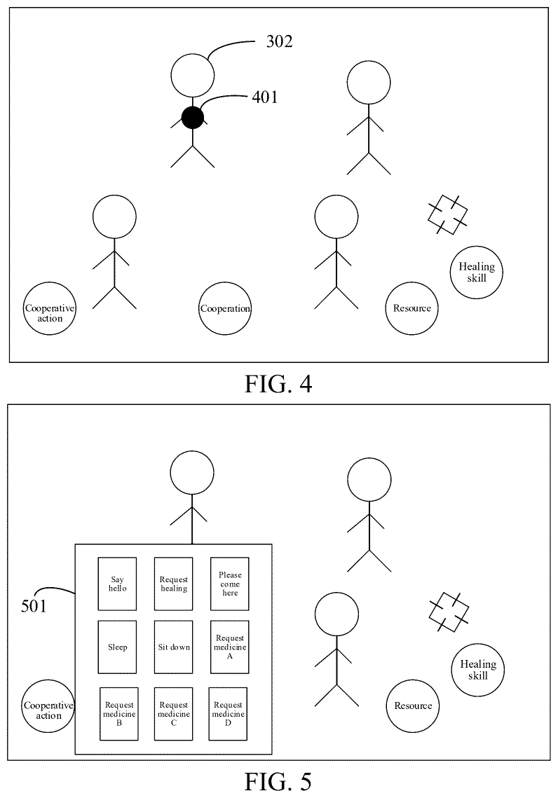

FIG. 3 is a schematic diagram of display of a game picture according to an embodiment of the present disclosure. FIG. 3 displays a first virtual object 301, a second virtual object 302, and two third virtual objects, respectively a first third virtual object 303 and a second third virtual object 304.

In one embodiment, a lock control may alternatively be displayed in the game picture, and 305 in FIG. 3 is the lock control. A cooperative object determining function is triggered in response to a trigger operation on the lock control. The cooperative object determining function is a function of determining a cooperative object of the first virtual object, and the cooperative object of the first virtual object is an object that can cooperate with the first virtual object in a game process.

For example, at least one reference virtual object is determined, in response to a trigger operation of the cooperative object determining function, among the at least one third virtual object, and distances corresponding to reference virtual objects and a distance corresponding to the second virtual object are determined, a distance corresponding to any reference virtual object being a distance between the reference virtual object and the first virtual object when the cooperative object determining function is triggered, and the distance corresponding to the second virtual object being a distance between the second virtual object and the first virtual object when the cooperative object determining function is triggered. A lock identifier is displayed, based on the distance corresponding to the second virtual object being less than the distances corresponding to reference virtual objects, at a target position of the second virtual object, the lock identifier being configured for indicating that the second virtual object is used as the cooperative object of the first virtual object. The reference virtual object and the first virtual object belong to the same game team.

After the cooperative object determining function is triggered, the second virtual object closest to the first virtual object is locked as the cooperative object of the first virtual object, which is beneficial to improving cooperative convenience between the first virtual object and the second virtual object, improving game experience of players, and further improving a human-computer interaction rate.

The target position of the second virtual object may be on the body of the second virtual object, on the head of the second virtual object, under the foots of the second virtual object, or on another position of the second virtual object. This is not limited in this embodiment of the present disclosure.

In a possible implementation, a process of determining the distance corresponding to each reference virtual object is similar to a process of determining the distance corresponding to the second virtual object. In this embodiment of the present disclosure, only the process of determining the distance corresponding to the second virtual object is used as an example for description.

For example, a process in which the first terminal device determines the distance corresponding to the second virtual object includes: the first terminal device acquires, in response to the trigger operation of the cooperative object determining function, position information of the first virtual object and position information of the second virtual object, and according to the position information of the first virtual object and the position information of the second virtual object, determines the distance between the second virtual object and the first virtual object (e.g., the distance corresponding to the second virtual object) when the cooperative object determining function is triggered.

For example, a process in which the first terminal device determines the distance corresponding to the second virtual object includes: the first terminal device transmits, in response to the trigger operation of the cooperative object determining function, a distance acquisition request to the server, the distance acquisition request including an object identifier of the first virtual object and an object identifier of the second virtual object. the server receives the distance acquisition request, and parses the distance acquisition request, to obtain the object identifier of the first virtual object and the object identifier of the second virtual object; the server determines the position information of the first virtual object according to the object identifier of the first virtual object, the position information of the second virtual object according to the object identifier of the second virtual object, and the distance between the second virtual object and the first virtual object (e.g., the distance corresponding to the second virtual object) when the cooperative object determining function is triggered according to the position information of the first virtual object and the position information of the second virtual object, and transmits the distance corresponding to the second virtual object to the first terminal device; and the first terminal device receives the distance corresponding to the second virtual object transmit by the server.

In a possible implementation, the second virtual object for establishing a cooperative relationship can also be determined through interaction with the server. The process includes: transmitting, in response to the trigger operation of the cooperative object determining function, a cooperative object determining request to the server, the cooperative object determining request including the object identifier of the first virtual object. The server receives the cooperative object determining request, and parses the cooperative object determining request, to obtain the object identifier of the first virtual object. The server acquires the position information of the first virtual object according to the object identifier of the first virtual object, determines at least one reference virtual object among the at least one third virtual object, and determines the distance corresponding to each reference virtual object and the distance corresponding to the second virtual object. Based on the distance corresponding to the second virtual object being less than the distances corresponding to the reference virtual objects, the second virtual object is used as a virtual object establishing a cooperative relationship with the first virtual object, and the identifier of the second virtual object is transmitted to the first terminal device so that the first terminal device knows which virtual object is recommended to establish a cooperative relationship with the first virtual object.

In one embodiment, the lock identifier may be any identifier. This is not limited in this embodiment of the present disclosure.

FIG. 4 is a schematic diagram of display of another game picture according to an embodiment of the present disclosure. In FIG. 4, a lock identifier 401 is displayed on the body of the second virtual object 302. The lock identifier in FIG. 4 is a black circle.

In one embodiment, based on the distance corresponding to any reference virtual object being less than the distances corresponding to other reference virtual objects and the distance corresponding to the second virtual object, the lock identifier is displayed at a target position of any reference virtual object.

A cooperation control may alternatively be displayed in the game picture, and 306 in FIG. 3 is the cooperation control. After the lock identifier is displayed at the target position of the second virtual object, if the first object determines to use the second virtual object as the cooperative object of the first virtual object, the first object selects the cooperation control, and triggers, in response to a trigger operation on the cooperation control, a cooperative relationship establishing function. A cooperative relationship between the first virtual object and the second virtual object is established in response to a trigger operation of the cooperative relationship establishing function.

The first object selecting the cooperation control may refer to the first object clicking on the cooperation control, the first object selecting the cooperation control through voice, or the first object selecting the cooperation control in another manner. A manner in which the first object selects the cooperation control is not limited in this embodiment of the present disclosure.

In one embodiment, a process of establishing, in response to the trigger operation of the cooperative relationship establishing function, a cooperative relationship between the first virtual object and the second virtual object includes: transmitting, in response to the trigger operation of the cooperative relationship establishing function, a cooperative relationship establishing request to a terminal device (the second terminal device) corresponding to the second virtual object, the cooperative relationship establishing request including the object identifier of the first virtual object and the object identifier of the second virtual object, and the cooperative relationship establishing request being configured for indicating that the first virtual object requests to establish the cooperative relationship with the second virtual object. A cooperative relationship between the first virtual object and the second virtual object is established in response to information of accepting the cooperative relationship establishing request returned by the second terminal device.

The second terminal device returns information of accepting the cooperative relationship establishing request, indicating that the second object agrees to establish a cooperative relationship between the first virtual object and the second virtual object. In this case, the cooperative relationship between the first virtual object and the second virtual object is established again, which is beneficial to improving reliability of establishing the cooperative relationship, improving game experience of players, and further improving a human-computer interaction rate.

For example, the first terminal device transmitting the cooperative relationship establishing request to the second terminal device may refer to the first terminal device directly transmitting the cooperative relationship establishing request to the second terminal device, or the first terminal device transmitting the cooperative relationship establishing request to the second terminal device through the server. This is not limited in this embodiment of the present disclosure.

For example, a process in which the first terminal device transmits the cooperative relationship establishing request to the second terminal device through the server includes: the first terminal device transmits the cooperative relationship establishing request to the server, and the server transmits the cooperative relationship establishing request to the second terminal device. After receiving the cooperative relationship establishing request, the server parses the cooperative relationship establishing request, to obtain the object identifier of the first virtual object and the object identifier of the second virtual object, and further transmits the cooperative relationship establishing request to the second terminal device corresponding to the second virtual object.

After receiving the cooperative relationship establishing request, the second terminal device corresponding to the second virtual object displays an agree control and a reject control, where the agree control is configured for instructing the second virtual object to determine that the second virtual object establishes a cooperative relationship with the first virtual object, and the reject control is configured for instructing the second virtual object to reject that the second virtual object establishes a cooperative relationship with the first virtual object.

The second terminal device corresponding to the second virtual object returns, in response to a trigger operation on the agree control, information of accepting the cooperative relationship establishing request to the first terminal device. For example, the second terminal device returning information of accepting the cooperative relationship establishing request to the first terminal device may refer to the second terminal device directly returning information of accepting the cooperative relationship establishing request to the first terminal device, or the second terminal device returning information of accepting the cooperative relationship establishing request to the first terminal device through the server. When the second terminal device returns information of accepting the cooperative relationship establishing request to the first terminal device through the server, the second terminal device transmits information that the second virtual object accepts the cooperative relationship establishing request to the server, the server receives the information of accepting the cooperative relationship establishing request returned by the second terminal device corresponding to the second virtual object, and the server transmits the information of accepting the cooperative relationship establishing request returned by the second terminal device to the first terminal device so that the first terminal device establishes, in response to the information of accepting the cooperative relationship establishing request returned by the second terminal device, a cooperative relationship between the first virtual object and the second virtual object.

The second terminal device corresponding to the second virtual object returns, in response to a trigger operation on the reject control, information of rejecting the cooperative relationship establishing request to the first terminal device. For example, the second terminal device returning information of rejecting the cooperative relationship establishing request to the first terminal device may refer to the second terminal device directly returning information of rejecting the cooperative relationship establishing request to the first terminal device, or the second terminal device returning information of rejecting the cooperative relationship establishing request to the first terminal device through the server. When the second terminal device returns information of rejecting the cooperative relationship establishing request to the first terminal device through the server, the second terminal device transmits information that the second virtual object rejects the cooperative relationship establishing request to the server, the server receives the information of rejecting the cooperative relationship establishing request returned by the second terminal device corresponding to the second virtual object, and transmits a notification message to the first terminal device, the notification message including information of rejecting the cooperative relationship establishing request and being configured for indicating that the second virtual object refuses to establish a cooperative relationship with the first virtual object. In this case, the first object may select another virtual object to establish a cooperative relationship with the first virtual object.

In some embodiments, the cooperative relationship between the first virtual object and the second virtual object may alternatively be established by the server. For example, the server establishes, in response to information of accepting the cooperative relationship establishing request returned by the second terminal device, the cooperative relationship between the first virtual object and the second virtual object. For example, when the cooperative relationship between the first virtual object and the second virtual object is established by the server, the server may transmit prompt information indicating that the cooperative relationship has been successfully established to the first terminal device after establishing the cooperative relationship between the first virtual object and the second virtual object, the prompt information being configured for prompting the first terminal device that the cooperative relationship between the first virtual object and the second virtual object has been successfully established.

In a possible implementation, after the lock identifier is displayed at the target position of the second virtual object, if the first object does not want the second virtual object to establish a cooperative relationship with the first virtual object, the first object can also select a virtual object establishing a cooperative relationship with the first virtual object in a self-selection manner, and then establish a cooperative relationship. In one embodiment, the lock identifier is displayed, in response to a trigger operation on a fourth virtual object, at a target position of the fourth virtual object, and the display of the lock identifier is canceled at the target position of the second virtual object, the fourth virtual object being any virtual object among the at least one third virtual object that belongs to the same game team as the first virtual object. A cooperative relationship between the first virtual object and the fourth virtual object is established in response to the trigger operation of the cooperative relationship establishing function.

A process of establishing the cooperative relationship between the first virtual object and the fourth virtual object is similar to the foregoing process of establishing the cooperative relationship between the first virtual object and the second virtual object. This is not limited in this embodiment of the present disclosure.

The first object can select a virtual object establishing a cooperative relationship with the first virtual object according to requirements, which is beneficial to improving flexibility of game interaction, improving game experience of the first object, and further improving a human-computer interaction rate.

In one embodiment, a relative position between the first virtual object and the second virtual object displayed in the game picture may be a face-to-face position, or another relative position. This is not limited in this embodiment of the present disclosure.

In operation 202, action identifiers of at least one candidate cooperative action are displayed in response to a trigger operation of a cooperative function.

In a possible implementation, a cooperative action control is further displayed in the game picture, and 307 in FIG. 3 is the cooperative action control. When the first virtual object is attacked by another virtual object and needs help, the first object selects the cooperative action control, and the first terminal device receives the trigger operation of a cooperative function, and displays, in response to the trigger operation of a cooperative function, action identifiers of at least one candidate cooperative action.

In one embodiment, a cooperative action selection page is displayed in response to the trigger operation of a cooperative function, the action identifiers of at least one candidate cooperative action being displayed in the cooperative action selection page.

The first object selecting the cooperative action control may refer to the first object clicking on the cooperative action control, the first object selecting the cooperative action control through voice, or the first object selecting the cooperative action control in another manner. A manner in which the first object selects the cooperative action control is not limited in this embodiment of the present disclosure. The cooperative action selection page can be displayed separately or in the game picture in a superposing manner. This is not limited in this embodiment of the present disclosure.

The at least one candidate cooperative action refers to a cooperative action by which another virtual objects can provide cooperation content for the first virtual object. The at least one candidate cooperative action can be set based on experience or flexibly adjusted according to the type, level, and hit point of the first virtual object. This is not limited in this embodiment of the present disclosure. For example, the at least one candidate cooperative action may include, but is not limited to, a resource acquisition action and a healing action. Cooperation content corresponding to the resource acquisition action refers to transferring resources to the first virtual object, and cooperation content corresponding to the healing action refers to increasing the hit point of the first virtual object. The action identifier of the candidate cooperative action may be an action name of the candidate cooperative action, or another identifier that can uniquely represent the candidate cooperative action. This is not limited in this embodiment of the present disclosure.

FIG. 5 is a schematic diagram of display of a cooperative action selection page according to an embodiment of the present disclosure. A cooperative action selection page 501 shown in FIG. 5 is displayed in the game picture in a superposing manner. Action identifiers of multiple candidate cooperative actions are displayed in the cooperative action selection page.

In a possible implementation, when the first virtual object is attacked by another virtual object, the first object may immediately select the cooperative action control to seek the help of the second virtual object. Alternatively, the first object may control the first virtual object to head to a relatively safe area. When the first virtual object is in the relatively safe area, the first object selects the cooperative action control to seek the help of the second virtual object. For example, the first object controls the first virtual object to hide behind the backplane. The reason for first controlling the first virtual object to head to a relatively safe area is to prevent the first virtual object from being continuously attacked, which leads to the elimination of the first virtual object.

In operation 203, in response to a trigger operation on an action identifier of a first cooperative action among at least one candidate cooperative action, a first cooperation request including first voiceprint information is transmitted to a second terminal device corresponding to the second virtual object, the first cooperation request being configured for providing cooperation content corresponding to the first cooperative action for the first virtual object by the second terminal device based on the first voiceprint information, and the first voiceprint information being determined based on the action identifier of the first cooperative action.

The first cooperative action may be any candidate cooperative action of at least one candidate cooperative action.

In a possible implementation, a cooperative action corresponds to a distance threshold. Distance thresholds corresponding to different cooperative actions may be the same or may be different. This is not limited in this embodiment of the present disclosure. In response to a trigger operation on an action identifier of a first cooperative action among at least one candidate cooperative action, a first distance between the first virtual object and the second virtual object when the action identifier of the first cooperative action is triggered is established. Based on the first distance being less than a first distance threshold, a first cooperation request including first voiceprint information is transmitted to the second terminal device. The first cooperation request is transmitted to the second terminal device when the distance between the first virtual object and the second virtual object is less than the distance threshold, to avoid a phenomenon that the second terminal device cannot provide cooperation content for the first virtual object according to the first cooperation request because the distance between the first virtual object and the second virtual object is too far, which is beneficial to improving a success rate of providing cooperation content for the first virtual object by the second terminal device according to the first cooperation request, and also beneficial to reducing resources consumed by transmitting the first cooperation request.

When different cooperative actions correspond to different distance thresholds, the first distance threshold is a distance threshold corresponding to the first cooperative action. When different cooperative actions correspond to the same distance threshold, the first distance threshold is a distance threshold corresponding to each cooperative action. The first distance threshold is set based on experience, or adjusted according to an implementation environment. This is not limited in this embodiment of the present disclosure. For example, the first distance threshold is 50 meters. That is, as long as a distance between the first virtual object and the second virtual object is less than 50 meters when the action identifier of the first cooperative action is triggered, the first cooperation request including first voiceprint information is transmitted to the second terminal device.

In an exemplary embodiment, the first terminal device transmitting the first cooperation request including first voiceprint information to the second terminal device may refer to the first terminal device directly transmitting the first cooperation request including first voiceprint information to the second terminal device. For example, the first terminal device stores voiceprint information corresponding to each cooperative action and a correspondence between an action identifier of each cooperative action and voiceprint information of each cooperative action, and the first terminal device may determine first voiceprint information corresponding to the first cooperative action according to the action identifier of the first cooperative action and the correspondence between an action identifier of each cooperative action and voiceprint information of each cooperative action, and then transmit the first cooperation request including first voiceprint information to the second terminal device.

In an exemplary embodiment, the first terminal device transmitting the first cooperation request including first voiceprint information to the second terminal device may alternatively refer to the first terminal device transmitting the first cooperation request including first voiceprint information to the second terminal device through the server. For example, a process in which the first terminal device transmits the first cooperation request including first voiceprint information to the second terminal device through the server includes: the first terminal device transmits a second cooperation request including the action identifier of the first cooperative action to the server, the second cooperation request being configured for transmitting the first cooperation request including first voiceprint information to the second terminal device by the server. By transmitting the first cooperation request to the second terminal device, the server may perform an operation of converting identifier information of the first cooperative action into the first voiceprint information, thereby saving computing resources of the first terminal device, and improving running smoothness of the first terminal device. For example, the first terminal device transmits the second cooperation request including the action identifier of the first cooperative action to the server based on the first distance being less than the first distance threshold.

The server receives the second cooperation request, and parses the second cooperation request, to obtain the action identifier of the first cooperative action, and determines the first voiceprint information corresponding to the first cooperative action according to the action identifier of the first cooperative action. The server transmits the first cooperation request to the second terminal device corresponding to the second virtual object, the first cooperation request including first voiceprint information, and the first cooperation request being configured for providing cooperation content corresponding to the first cooperative action for the first virtual object by the second terminal device corresponding to the second virtual object based on the first voiceprint information.

In one embodiment, the server stores voiceprint information corresponding to each cooperative action and a correspondence between an action identifier of each cooperative action and voiceprint information of each cooperative action. After obtaining the action identifier of the first cooperative action, the server determines the first voiceprint information corresponding to the first cooperative action according to the action identifier of the first cooperative action and the correspondence between an action identifier of each cooperative action and voiceprint information of each cooperative action.

In a possible implementation, in response to a trigger operation on an action identifier of a first cooperative action among at least one candidate cooperative action, the first virtual object may further be controlled to perform the first cooperative action. After the first object triggers the action identifier of the first cooperative action, the first virtual object is controlled to perform the first cooperative action so that the first object can be intuitively notified of a triggered cooperative action, and game images can be enriched, which is beneficial to improving game experience of players, and further improving a human-computer interaction rate.

In a possible implementation, the first cooperation request transmitted by the first terminal device to the second terminal device further includes a first multimedia resource, the first multimedia resource being a multimedia resource for the first virtual object to perform the first cooperative action. For example, the first multimedia resource is a video for the first virtual object to perform the first cooperative action, or the first multimedia resource is a picture for the first virtual object to perform the first cooperative action. For example, the second cooperation request transmitted by the first terminal device to the server may alternatively include the first multimedia resource so that when transmitting the first cooperation request to the second terminal device, the server adds the first multimedia resource into the first cooperation request.

The first multimedia resource is added to the first cooperation request so that when the second object controlling the second virtual object cannot determine which help is needed by the first virtual object according to the first voiceprint information, the second object can learn what help is needed by the first virtual object according to the first multimedia resource, thereby improving efficiency of controlling the second terminal device by the second object to provide cooperation content corresponding to the first cooperative action for the first virtual object, improving game experience of players, and further improving a human-computer interaction rate.

The process in which the second virtual object provides cooperation content corresponding to the first cooperative action for the first virtual object is similar to the following process in which the first virtual object provides cooperation content corresponding to a second cooperative action for the second virtual object. Details are not described herein again.

After the cooperative relationship is established between the first virtual object and the second virtual object, the second virtual object can provide help for the first virtual object when the first virtual object needs help, and the first virtual object also can provide help for the second virtual object when the second virtual object needs help.

When the second virtual object needs help, the second terminal device corresponding to the second virtual object transmits a third cooperation request to the first terminal device, the third cooperation request including second voiceprint information of the second cooperative action, and the third cooperation request being configured for providing cooperation content corresponding to the second cooperative action for the second virtual object. The first terminal device receives the third cooperation request, and provides the cooperation content corresponding to the second cooperative action for the second virtual object based on the second voiceprint information. After the cooperative relationship is established between the first virtual object and the second virtual object, the first virtual object and the second virtual object can help each other, which is beneficial to improving game experience of players, and further improving a human-computer interaction rate.

In an exemplary embodiment, the second terminal device transmitting a third cooperation request to the first terminal device may refer to the second terminal device directly transmitting a third cooperation request to the first terminal device. For example, the second terminal device stores voiceprint information corresponding to each cooperative action and a correspondence between an action identifier of each cooperative action and voiceprint information of each cooperative action, and the second terminal device may determine second voiceprint information corresponding to the second cooperative action according to the action identifier of the second cooperative action and the correspondence between an action identifier of each cooperative action and voiceprint information of each cooperative action, and then transmit the third cooperation request including second voiceprint information to the first terminal device.

In an exemplary embodiment, the second terminal device transmitting a third cooperation request to the first terminal device may refer to the second terminal device transmitting a third cooperation request to the first terminal device through the server. For example, a process in which the second terminal device transmits a third cooperation request to the first terminal device through the server includes: the second terminal device transmits a fourth cooperation request to the server, the fourth cooperation request including the action identifier of the second cooperative action, and the fourth cooperation request being configured for transmitting the third cooperation request to the first terminal device by the server. The server receives the fourth cooperation request, and parses the fourth cooperation request, to obtain the action identifier of the second cooperative action, and determines the second voiceprint information corresponding to the second cooperative action according to the action identifier of the second cooperative action; and the third cooperation request is generated according to the second voiceprint information, and transmitted to the first terminal device. By transmitting the third cooperation request to the first terminal device, the server may perform an operation of converting identifier information of the second cooperative action into the second voiceprint information, thereby saving computing resources of the second terminal device, and improving running smoothness of the second terminal device.

In an exemplary embodiment, the third cooperation request further includes a second multimedia resource, the second multimedia resource being a multimedia resource for the second virtual object to perform the second cooperative action. In this case, the fourth cooperation request transmitted by the second terminal device to the server includes the action identifier of the second cooperative action and the second multimedia resource. After determining the second voiceprint information, the server generates the third cooperation request according to the second voiceprint information and the second multimedia resource, the third cooperation request including the second voiceprint information and the second multimedia resource.

The first terminal device receives the third cooperation request, and parses the third cooperation request, to obtain the second voiceprint information corresponding to the second cooperative action, and further provides cooperation content corresponding to the second cooperative action for the second virtual object based on the second voiceprint information.

In an exemplary embodiment, the first terminal device stores a correspondence between voiceprint information and a cooperative action as well as cooperation content corresponding to the cooperative action. A process of providing cooperation content corresponding to the second cooperative action for the second virtual object based on the second voiceprint information includes: the first terminal device determines the second cooperative action according to the correspondence between voiceprint information and a cooperative action as well as the second voiceprint information, and then directly provides the cooperation content corresponding to the second cooperative action for the second virtual object. This manner is beneficial to improving efficiency of providing the cooperation content corresponding to the second cooperative action for the second virtual object by the first terminal device.

In an exemplary embodiment, a process of providing cooperation content corresponding to the second cooperative action for the second virtual object based on the second voiceprint information includes: displaying the second voiceprint information, and providing, in response to a first operation on the second voiceprint information, cooperation content corresponding to the second cooperative action for the second virtual object. After acquiring the first operation on the second voiceprint information, the first terminal device provides the cooperation content corresponding to the second cooperative action for the second virtual object, to ensure that the first terminal device provides the cooperation content corresponding to the second cooperative action for the second virtual object according to a subjective operation of the first object, thereby improving relevance between a process of providing the cooperation content and the subjective operation of the first object, improving game experience of the first object, and further improving a human-computer interaction rate.

In one embodiment, a process of displaying the second voiceprint information includes: displaying the second voiceprint information in the game picture. For example, the display position of the second voiceprint information in the game picture can be set based on experience, or may be flexibly adjusted according to requirements. This is not limited in this embodiment of the present disclosure. For instance, the second voiceprint information may be displayed in a top area of the game picture, or may be displayed in a bottom area of the game picture.

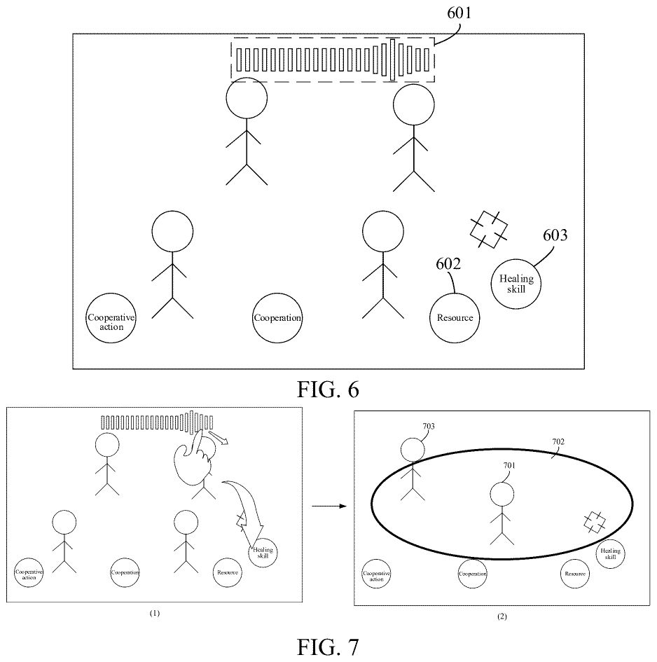

FIG. 6 is a schematic diagram of display of yet another game picture according to an embodiment of the present disclosure. Second voiceprint information 601 is displayed in the game picture in FIG. 6.

The first operation on the second voiceprint information is an operation generated on the second voiceprint information for triggering the first terminal device to provide the cooperation content corresponding to the second cooperative action for the second virtual object. The type of the first operation can be set according to the type of the second cooperative action, or may be flexibly adjusted according to actual application scenarios. This is not limited in this embodiment of the present disclosure.

In a possible implementation, a resource acquisition action is based on the second cooperative action, and a resource control is further displayed in the game picture. 602 in FIG. 6 is a resource control. The first operation on the second voiceprint information is an operation of dragging the second voiceprint information to an area of the resource control. A process of providing, in response to a first operation on the second voiceprint information, cooperation content corresponding to the second cooperative action for the second virtual object includes: displaying a resource page in response to the operation of dragging the second voiceprint information to the area of the resource control, resource information of at least one type of resource being displayed in the resource page, and the at least one type of resource being a resource already possessed by the first object; and transferring, in response to a trigger operation on resource information of target resources among the at least one type of resource, the target resources to the second virtual object. The first object can provide cooperation content for the second virtual object by transferring target resources to the second virtual object so that the second virtual object timely supplements the target resources in a game process, which is beneficial to improving game experience of players, and further improving a human-computer interaction rate. In addition, the first object can flexibly select the target resources to be transferred to the second virtual object so that interaction flexibility is relatively high, which is beneficial to improving game experience of the first object, and further improving a human-computer interaction rate.

For example, the area of the resource control is an area where the resource control is located in the game picture.

For example, the resource page can be displayed separately or in the game picture in a superposing manner. This is not limited in this embodiment of the present disclosure.

In a possible implementation, a quantity determining box is displayed in response to the trigger operation on resource information of target resources among the at least one type of resource, the quantity determining box being configured for determining a target quantity of target resources to be transferred to the second virtual object; and the target quantity is obtained based on the quantity determining box to transfer target resources of the target quantity to the second virtual object. The first object can set the quantity of the target resources to be transferred to the second virtual object so that interaction flexibility is relatively high, which is beneficial to improving game experience of the first object, and further improving a human-computer interaction rate.

In one embodiment, a process of displaying a resource page in response to the operation of dragging the second voiceprint information to an area of the resource control includes: determining, in response to the operation of dragging the second voiceprint information to the area of the resource control, a third distance between the first virtual object and the second virtual object when the second voiceprint information is dragged to the area of the resource control; and displaying, based on the third distance being less than a third distance threshold, a resource page. The resource page is displayed when the distance between the first virtual object and the second virtual object is less than the distance threshold, to avoid a phenomenon that the first terminal device cannot transfer resources to the second virtual object according to the displayed resource page because the distance between the first virtual object and the second virtual object is too far, which is beneficial to improving a success rate of transferring resources to the second virtual object by the first terminal device according to the displayed resource page, and also beneficial to saving resources consumed by displaying the resource page.

For example, the third distance threshold is set based on experience, or adjusted according to an implementation environment. This is not limited in this embodiment of the present disclosure. For example, the third distance threshold is 30 meters.

In another possible implementation, a healing action is based on the second cooperative action, and a healing skill control is further displayed in the game picture. 603 in FIG. 6 is a healing skill control. The first operation on the second voiceprint information is an operation of dragging the second voiceprint information to an area of the healing skill control. The process of providing, in response to a first operation on the second voiceprint information, cooperation content corresponding to the second cooperative action for the second virtual object includes: determining, in response to the operation of dragging the second voiceprint information to an area of the healing skill control, a second distance between the first virtual object and the second virtual object when the second voiceprint information is dragged to the area of the healing skill control; and controlling, based on the second distance being less than a second distance threshold, the first virtual object to cast a healing skill, the healing skill being configured for increasing a hit point of the second virtual object. The first object can provide cooperation content for the second virtual object by casting a healing skill to the second virtual object so that the second virtual object is timely healed in a game process, which is beneficial to improving game experience of players, and further improving a human-computer interaction rate.

Because the healing skill has a particular effective range, the second virtual object can increase a hit point using the healing skill only when the second virtual object falls within the effective range. Therefore, when the first virtual object casts the healing skill, it is necessary to first determine whether the second distance between the second virtual object and the first virtual object when the second voiceprint information is dragged to the area of the healing skill control is less than the second distance threshold. If the second distance is less than the second distance threshold, when the first virtual object casts the healing skill, the second virtual object can increase a hit point using the healing skill. If the second distance is not less than the second distance threshold, the first virtual object casts the healing skill, and the second virtual object cannot increase a hit point using the healing skill. Therefore, prompt information is displayed, the prompt information being configured for indicating that the distance between the second virtual object and the first virtual object is too far.

In one embodiment, the second distance threshold is set based on experience, or adjusted according to an implementation environment. This is not limited in this embodiment of the present disclosure. For example, the second distance threshold is 30 meters.

In a possible implementation, a target area is determined according to position information of the first virtual object based on the second distance being less than a second distance threshold, the second virtual object being located in the target area; and the first virtual object is controlled to cast the healing skill in the target area. That the second virtual object can be healed is ensured by controlling the first virtual object to cast the healing skill in the target area so that operation convenience is relatively high, which is beneficial to improving game experience of players, and further improving a human-computer interaction rate.

For example, a process of determining a target area according to the position information of the first virtual object includes: using a circle determined with the position indicated by the position information of the first virtual object as the center and the second distance threshold as the radius as the target area.

FIG. 7 is a schematic diagram of display of a target area according to an embodiment of the present disclosure. In (1) of FIG. 7, the second voiceprint information is dragged to the area of the healing skill control. In (2) of FIG. 7, a target area 702 is determined with the position indicated by the position information of the first virtual object 701 as the center of a circle and the second distance threshold as the radius. The distance between the second virtual object 703 and the first virtual object 701 is less than the second distance threshold. Therefore, the second virtual object 703 is located in the target area 702.

In one embodiment, after the first virtual object casts the healing skill, the hit point of the second virtual object is increased, and the quantity of the increased hit point of the second virtual object is a reference quantity. The reference quantity is set based on experience, or adjusted according to an implementation environment. This is not limited in this embodiment of the present disclosure. For example, the reference quantity is 20.

Based on the difference between the hit point of the second virtual object and the maximum hit point of the second virtual object being not less than the reference quantity, after the first virtual object casts the healing skill, the hit point of the second virtual object is increased by the reference quantity. Based on the difference between the hit point of the second virtual object and the maximum hit point of the second virtual object being less than the reference quantity, after the first virtual object casts the healing skill, the hit point of the second virtual object is increased by the maximum hit point of the second virtual object.

For example, the maximum hit point of the second virtual object is 100, and the reference quantity is 20. Based on the hit point of the second virtual object being 75, after the first virtual object casts the healing skill, the hit point of the second virtual object is increased by 20, and the increased hit point of the second virtual object is 95. Based on the hit point of the second virtual object being 90, after the first virtual object casts the healing skill, the hit point of the second virtual object is increased to 100, e.g., the increased hit point of the second virtual object is 100.

In a possible implementation, after the first virtual object is controlled to cast the healing skill in the target area, the healing skill is further configured for increasing a hit point of a fifth virtual object based on the fifth virtual object being located in the target area, and the fifth virtual object and the first virtual object belong to the same game team. That is, the healing skill is further configured for increasing the hit point of the fifth virtual object located in the target area. The healing skill cast by the first virtual object not only can increase the hit point of the second virtual object, but also can increase a hit point of another virtual object belonging to the same game team as the first virtual object in the target area so that the healing skill has a relatively good effect and relatively high efficiency. A process of increasing the hit point of the fifth virtual object is similar to the foregoing process of increasing the hit point of the second virtual object. This is not limited in the present disclosure.

In a possible implementation, the third cooperation request further includes the second multimedia resource. The second multimedia resource is displayed in response to a second operation on the second voiceprint information. The second multimedia resource is added to the third cooperation request so that when the first object controlling the first virtual object cannot determine which help is needed by the second virtual object according to the second voiceprint information, the first object can learn what help is needed by the second virtual object according to the second multimedia resource, thereby improving efficiency of controlling the first terminal device by the first object to provide cooperation content corresponding to the second cooperative action for the second virtual object, improving game experience of players, and further improving a human-computer interaction rate.

For example, the second operation on the second voiceprint information may be an operation of long-pressing the second voiceprint information, or may be an operation of clicking (for example, single-clicking or double-clicking) the second voiceprint information. A process of displaying the second multimedia resource includes: displaying the second multimedia resource in the game picture. For example, if the second multimedia resource is a video for the second virtual object to perform the second cooperative action, the video for the second virtual object to perform the second cooperative action is played in the game picture. For another example, if the second multimedia resource is a picture for the second virtual object to perform the second cooperative action, the picture for the second virtual object to perform the second cooperative action is displayed in the game picture.

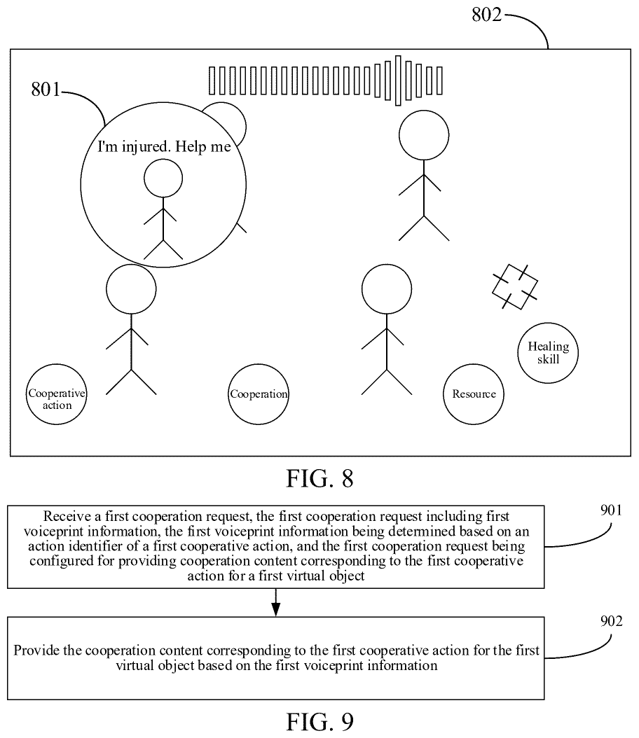

FIG. 8 is a schematic diagram of display of a second multimedia resource according to an embodiment of the present disclosure. The second multimedia resource 801 shown in FIG. 8 is displayed in the game picture 802.

According to the foregoing method, when the first virtual object needs help, the cooperative function is triggered to display the action identifier of the candidate cooperative action so that the action identifier of the first cooperative action is triggered in the action identifier of the candidate cooperative action, and the first cooperation request including the first voiceprint information of the first cooperative action is transmitted to the second terminal device corresponding to the second virtual object. Thus, the second virtual object timely provides the help needed by the first virtual object for the first virtual object. In this manner, timely and effective communication between two players can be achieved without voice interaction between a player controlling the first virtual object and a player controlling the second virtual object, which enriches communication manners between the two players, thereby improving the flexibility and diversity of game interaction, improving game experience of the players, and further improving a human-computer interaction rate.

An embodiment of the present disclosure provides a game interaction method, which can be applied to the implementation environment shown in FIG. 1. By taking a flowchart of a game interaction method according to an embodiment of the present disclosure shown in FIG. 9 as an example, the method may be performed by the second terminal device 103 in FIG. 1. As shown in FIG. 9, the method includes the following operation 901 and operation 902.

In operation 901, a first cooperation request is received, the first cooperation request including first voiceprint information, the first voiceprint information being determined based on an action identifier of a first cooperative action, and the first cooperation request being configured for providing cooperation content corresponding to the first cooperative action for a first virtual object;

For example, the first cooperation request transmitted by the first terminal device is received. Receiving the first cooperation request transmitted by the first terminal device may refer to receiving the first cooperation request directly transmitted by the first terminal device, or receiving the first cooperation request transmitted by the first terminal device through the server.

The related content of the first cooperation request is shown in operation 203 in an embodiment shown in FIG. 2. Details are not described herein again.

In operation 902, cooperation content corresponding to the first cooperative action is provided for the first virtual object based on the first voiceprint information.

In a possible implementation, a process of providing cooperation content corresponding to the first cooperative action for the first virtual object based on the first voiceprint information includes: displaying the first voiceprint information; and providing, in response to a first operation on the first voiceprint information, cooperation content corresponding to the first cooperative action for the first virtual object.

For example, the second terminal device displays a game picture, the game picture including a first virtual object and a second virtual object located in a virtual environment. The displaying the first voiceprint information may refer to displaying the first voiceprint information in the game picture.

In a possible implementation, the first cooperative action is a resource acquisition action, and a resource control is further displayed in the game picture of the second terminal device. The first operation on the first voiceprint information is an operation of dragging the first voiceprint information to an area of the resource control in the game picture. A process of providing, in response to a first operation on the first voiceprint information, cooperation content corresponding to the first cooperative action for the first virtual object includes: displaying a resource page in response to the operation of dragging the first voiceprint information to an area of the resource control, resource information of at least one type of resource being displayed in the resource page, and the at least one type of resource being a resource already possessed by the second virtual object; and transferring, in response to a trigger operation on resource information of target resources among the at least one type of resource, target resources to the first virtual object.

In an exemplary embodiment, a process of transferring, in response to a trigger operation on resource information of target resources among the at least one type of resource, target resources to the first virtual object includes: displaying a quantity determining box in response to the trigger operation on the resource information of the target resources among the at least one type of resource, the quantity determining box being configured for determining a target quantity of the target resources to be transferred to the first virtual object; and acquiring the target quantity based on the quantity determining box, and transferring the target resources of the target quantity to the second virtual object.

In an exemplary embodiment, a process of displaying a resource page in response to the operation of dragging the first voiceprint information to an area of the resource control includes: determining, in response to the operation of dragging the first voiceprint information to an area of the resource control, a fourth distance between the first virtual object and the second virtual object when the first voiceprint information is dragged to the area of the resource control; and displaying, based on the fourth distance being less than a fourth distance threshold, a resource page.

In a possible implementation, the first cooperative action is a healing action, and a healing skill control is further displayed in the game picture. The first operation on the first voiceprint information is an operation of dragging the first voiceprint information to an area of the healing skill control in the game picture. The process of providing, in response to a first operation on the first voiceprint information, cooperation content corresponding to the first cooperative action for the first virtual object includes: determining, in response to the operation of dragging the first voiceprint information to an area of the healing skill control, a fifth distance between the first virtual object and the second virtual object when the first voiceprint information is dragged to the area of the healing skill control; and controlling the second virtual object to cast a healing skill based on the fifth distance being less than a fifth distance threshold, the healing skill being configured for increasing a hit point of the first virtual object.

In an exemplary embodiment, a process of controlling the second virtual object to cast a healing skill based on the fifth distance being less than a fifth distance threshold includes: determining a target area according to the position information of the second virtual object based on the fifth distance being less than a fifth distance threshold, the fifth virtual object being located in the target area; and controlling the second virtual object to cast the healing skill in the target area.

In an exemplary embodiment, the healing skill is further configured for increasing a hit point of a sixth virtual object located in the target area, and the sixth virtual object and the second virtual object belong to the same game team.

In a possible implementation, the first cooperation request further includes a first multimedia resource, the first multimedia resource being a multimedia resource for the first virtual object to perform the first cooperative action. The method further includes: displaying, in response to a second operation on the first voiceprint information, the first multimedia resource.

The foregoing implementation in which the second terminal device provides cooperation content corresponding to the first cooperative action for the first virtual object based on the first voiceprint information is based on the same principle as an implementation in which the first terminal device provides cooperation content corresponding to the second cooperative action for the second virtual object based on the second voiceprint information, introduced in an embodiment shown in FIG. 2. Details are not described herein again.

In a possible implementation, the second terminal device can further transmit a third cooperation request to the first terminal device, the third cooperation request including second voiceprint information of the second cooperative action, and the third cooperation request being configured for providing cooperation content corresponding to the second cooperative action for the second virtual object by the first terminal device. An implementation in which the second terminal device transmits the third cooperation request to the first terminal device is based on the same principle as an implementation in which the first terminal device transmits the first cooperation request to the second terminal device. Details are not described herein again.

According to the foregoing method, the second terminal device can receive the first cooperation request including first voiceprint information of the first cooperative action so that the second virtual object timely provides the help needed by the first virtual object for the first virtual object. In this manner, timely and effective communication between two players can be achieved without voice interaction between a player controlling the first virtual object and a player controlling the second virtual object, which enriches communication manners between the two players, thereby improving the flexibility and diversity of game interaction, improving game experience of the players, and further improving a human-computer interaction rate.

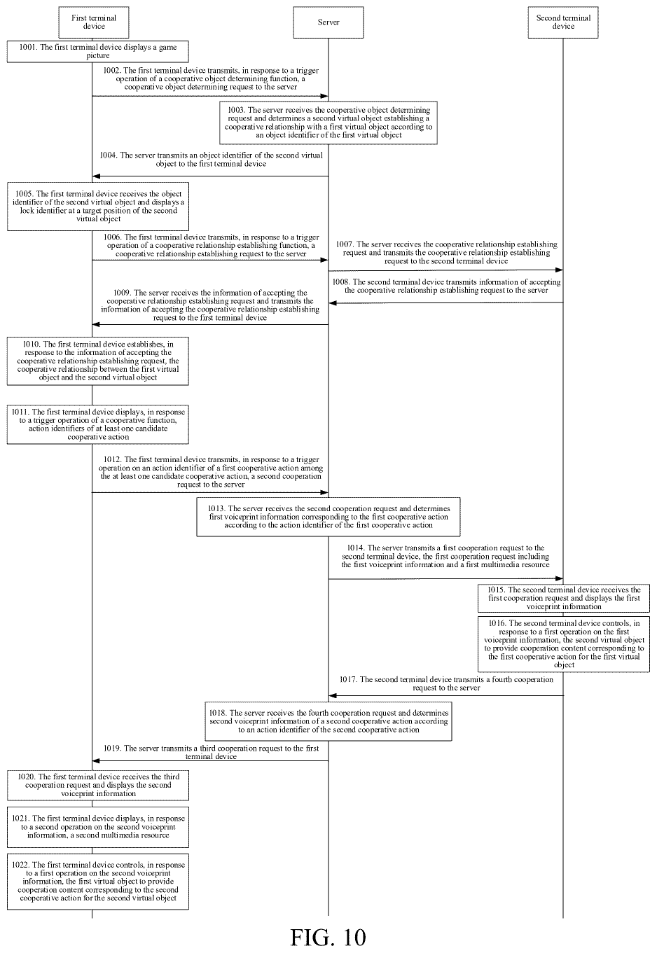

FIG. 10 is a flowchart of a game interaction method according to an embodiment of the present disclosure. The method can be implemented by interaction among the first terminal device 101, the server 102, and the second terminal device 103 in FIG. 1. As shown in FIG. 10, the method includes the following operation 1001 to operation 1022.

Operation 1001: The first terminal device displays a game picture.

The game picture includes a first virtual object, a second virtual object, and at least one third virtual object located in a virtual environment. The first virtual object and the second virtual object belong to the same game team. The third virtual object may belong to the same game team as the first virtual object, or may belong to a different game team from the first virtual object. This is not limited in this embodiment of the present disclosure.

A process in which the first terminal device displays a game picture has been described in operation 201 above. Details are not described herein again.

Operation 1002: The first terminal device transmits, in response to a trigger operation of a cooperative object determining function, a cooperative object determining request to the server.

The cooperative object determining request includes an object identifier of the first virtual object. The trigger operation of the cooperative object determining function has been described in operation 201 above, and a process of transmitting the cooperative object determining request to the server has been described in operation 201 above. Details are not described herein again.

Operation 1003: The server receives the cooperative object determining request and determines a second virtual object establishing a cooperative relationship with the first virtual object according to the object identifier of the first virtual object.

A process in which the server determines the second virtual object has been described in operation 201 above. Details are not described herein again.

Operation 1004: The server transmits an object identifier of the second virtual object to the first terminal device.

Operation 1005: The first terminal device receives the object identifier of the second virtual object and displays a lock identifier at a target position of the second virtual object.

A process in which a lock identifier is displayed at a target position of the second virtual object has been described in operation 201 above. Details are not described herein again.

In one embodiment, the first terminal device may further determine the second virtual object establishing a cooperative relationship with the first virtual object. The process has been described in operation 201 above. Details are not described herein again.

Operation 1006: The first terminal device transmits, in response to a trigger operation of a cooperative relationship establishing function, a cooperative relationship establishing request to the server.

The cooperative relationship establishing request includes an object identifier of a first object and an object identifier of a second object. The cooperative relationship establishing request is configured for indicating that the first virtual object requests to establish a cooperative relationship with the second virtual object. The trigger operation of the cooperative relationship establishing function has been described in operation 201 above, and a process of transmitting the cooperative relationship establishing request to the server has been described in operation 201 above. Details are not described herein again.

Operation 1007: The server receives the cooperative relationship establishing request and transmits the cooperative relationship establishing request to the second terminal device.

Operation 1008: The second terminal device transmits information of accepting the cooperative relationship establishing request to the server.

A process in which the second terminal device transmits information of accepting the cooperative relationship establishing request to the server has been described in operation 201 above. Details are not described herein again.

Operation 1009: The server receives the information of accepting the cooperative relationship establishing request and transmits the information of accepting the cooperative relationship establishing request to the first terminal device.

Operation 1010: The first terminal device establishes, in response to information of accepting the cooperative relationship establishing request, the cooperative relationship between the first virtual object and the second virtual object.

A process in which the first terminal device establishes a cooperative relationship between the first virtual object and the second virtual object has been described in operation 201 above. Details are not described herein again.

Operation 1011: The first terminal device displays, in response to a trigger operation of a cooperative function, action identifiers of at least one candidate cooperative action.

The trigger operation of a cooperative function has been described in operation 202 above. A process in which the first terminal device displays action identifiers of at least one candidate cooperative action has been described in operation 202 above. Details are not described herein again.

Operation 1012: The first terminal device transmits, in response to a trigger operation on an action identifier of a first cooperative action among at least one candidate cooperative action, a second cooperation request to the server.

The second cooperation request includes the action identifier of the first cooperative action and a first multimedia resource. A process in which the first terminal device transmits a second cooperation request to the server has been described in operation 203 above. Details are not described herein again. The first multimedia resource is a multimedia resource for the first virtual object to perform the first cooperative action.

Operation 1013: The server receives the second cooperation request and determines first voiceprint information corresponding to the first cooperative action according to the action identifier of the first cooperative action.

A process of determining first voiceprint information corresponding to the first cooperative action according to the action identifier of the first cooperative action has been described in operation 203 above. Details are not described herein again.

Operation 1014: The server transmits the first cooperation request to the second terminal device, the first cooperation request including the first voiceprint information and the first multimedia resource.

The process has been described in operation 203 above. Details are not described herein again.

Operation 1015: The second terminal device receives the first cooperation request and displays the first voiceprint information.

Operation 1016: The second terminal device controls, in response to a first operation on the first voiceprint information, the second virtual object to provide cooperation content corresponding to the first cooperative action for the first virtual object.

Operation 1017: The second terminal device transmits a fourth cooperation request to the server.

The fourth cooperation request includes an action identifier of a second cooperative action and a second multimedia resource. A process in which the second terminal device transmits a fourth cooperation request to the server has been described in operation 203 above. Details are not described herein again. The second multimedia resource is a multimedia resource for the second virtual object to perform the second cooperative action.

Operation 1018: The server receives the fourth cooperation request and determines second voiceprint information of the second cooperative action according to the action identifier of the second cooperative action.

A process of determining second voiceprint information of the second cooperative action according to the action identifier of the second cooperative action has been described in operation 203 above. Details are not described herein again.

Operation 1019: The server transmits a third cooperation request to the first terminal device.

The third cooperation request includes the second voiceprint information and the second multimedia resource. A process in which the server transmits a third cooperation request to the first terminal device has been described in operation 203 above. Details are not described herein again.

Operation 1020: The first terminal device receives the third cooperation request and displays the second voiceprint information.

A process in which the first terminal device displays the second voiceprint information has been described in operation 203 above. Details are not described herein again.

Operation 1021: The first terminal device displays, in response to a second operation on the second voiceprint information, the second multimedia resource.

A process in which the first terminal device displays the second multimedia resource has been described in operation 203 above. Details are not described herein again.

Operation 1022: The first terminal device controls the first virtual object to provide, in response to a first operation on the second voiceprint information, cooperation content corresponding to the second cooperative action for the second virtual object.

A process in which the first virtual object provides cooperation content corresponding to the second cooperative action for the second virtual object has been described in operation 203 above. Details are not described herein again.

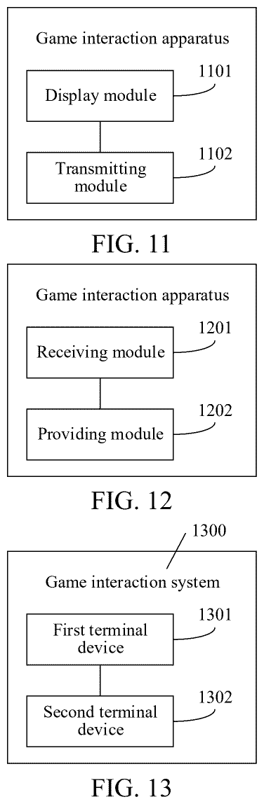

FIG. 11 is a schematic structural diagram of a game interaction apparatus according to an embodiment of the present disclosure. As shown in FIG. 11, the apparatus includes:
a display module 1101, configured to display a game picture, the game picture including a first virtual object and a second virtual object located in a virtual environment;
the display module 1101 being further configured to display, in response to a trigger operation of a cooperative function, action identifiers of at least one candidate cooperative action; and
a transmitting module 1102, configured to transmit, in response to a trigger operation on an action identifier of a first cooperative action among the at least one candidate cooperative action, a first cooperation request including first voiceprint information to a second terminal device corresponding to the second virtual object, the first cooperation request being configured for providing cooperation content corresponding to the first cooperative action for the first virtual object by the second terminal device based on the first voiceprint information, and the first voiceprint information being determined based on the action identifier of the first cooperative action.

In a possible implementation, the transmitting module 1102 is configured to establish, in response to a trigger operation on an action identifier of a first cooperative action among at least one candidate cooperative action, a first distance between the first virtual object and the second virtual object when the action identifier of the first cooperative action is triggered; and transmit a first cooperation request including first voiceprint information, based on the first distance being less than a first distance threshold, to the second terminal device.

In a possible implementation, the transmitting module 1102 is configured to transmit, in response to a trigger operation on an action identifier of a first cooperative action, a second cooperation request including the action identifier of the first cooperative action to the server, the second cooperation request being configured for transmitting the first cooperation request including first voiceprint information to the second terminal device by the server.

In a possible implementation, the second virtual object and the first virtual object belong to the same game team, and at least one third virtual object is further displayed in the game picture.

The apparatus further includes:
a determining module, configured to determine, in response to a trigger operation of a cooperative object determining function, at least one reference virtual object among the at least one third virtual object, the reference virtual object and the first virtual object belonging to the same game team; and determine distances corresponding to reference virtual objects and a distance corresponding to the second virtual object, a distance corresponding to the reference virtual object being a distance between any reference virtual object and the first virtual object when the cooperative object determining function is triggered, and the distance corresponding to the second virtual object being a distance between the second virtual object and the first virtual object when the cooperative object determining function is triggered;
a display module 1101, configured to display, based on the distance corresponding to the second virtual object being less than the distances corresponding to the reference virtual objects, a lock identifier at a target position of the second virtual object, the lock identifier being configured for indicating that the second virtual object is used as a cooperative object of the first virtual object; and
an establishing module, configured to establish, in response to a trigger operation of the cooperative relationship establishing function, a cooperative relationship between the first virtual object and the second virtual object.

In a possible implementation, the establishing module is configured to transmit, in response to a trigger operation of the cooperative relationship establishing function, a cooperative relationship establishing request to the second terminal device, and establish, in response to information of accepting the cooperative relationship establishing request returned by the second terminal device, a cooperative relationship between the first virtual object and the second virtual object, the cooperative relationship establishing request including the object identifier of the first virtual object and the object identifier of the second virtual object, and the cooperative relationship establishing request being configured for indicating that the first virtual object requests to establish a cooperative relationship with the second virtual object.

In a possible implementation, the display module 1101 is further configured to display, in response to a trigger operation on the fourth virtual object, the lock identifier at a target position of a fourth virtual object, and cancel the display of the lock identifier at the target position of the second virtual object, the fourth virtual object being any virtual object among the at least one third virtual object that belongs to the same game team as the first virtual object.

The establishing module is further configured to establish, in response to a trigger operation of the cooperative relationship establishing function, a cooperative relationship between the first virtual object and the second virtual object.

In a possible implementation, the apparatus further includes:
a control module, configured to control, in response to a trigger operation on an action identifier of a first cooperative action among at least one candidate cooperative action, the first virtual object to perform the first cooperative action.

In a possible implementation, the first cooperation request further includes a first multimedia resource, the first multimedia resource being a multimedia resource for the first virtual object to perform the first cooperative action.

In a possible implementation, the apparatus further includes:
a receiving module, configured to receive a third cooperation request, the third cooperation request including second voiceprint information of the second cooperative action, and the third cooperation request being configured for providing cooperation content corresponding to the second cooperative action for the second virtual object; and
a providing module, configured to provide the cooperation content corresponding to the second cooperative action for the second virtual object based on the second voiceprint information.

In a possible implementation, the display module 1101 is further configured to display the second voiceprint information;

The providing module is configured to provide, in response to a first operation on the second voiceprint information, cooperation content corresponding to the second cooperative action for the second virtual object.

In a possible implementation, the second cooperative action is a resource acquisition action, a resource control is further displayed in the game picture, and the first operation on the second voiceprint information is an operation of dragging the second voiceprint information to an area of the resource control.

The providing module is configured to display a resource page in response to the operation of dragging the second voiceprint information to an area of the resource control, resource information of at least one type of resource being displayed in the resource page, and the at least one type of resource being a resource already possessed by the first virtual object; and transfer, in response to a trigger operation on resource information of target resources among the at least one type of resource, the target resources to the second virtual object.

In a possible implementation, the providing module is configured to display a quantity determining box in response to the trigger operation on resource information of target resources among the at least one type of resource, the quantity determining box being configured for determining a target quantity of target resources to be transferred to the second virtual object; and acquire the target quantity based on the quantity determining box and transfer the target resources of the target quantity to the second virtual object.

In a possible implementation, the display module 1101 is configured to determine, in response to the operation of dragging the second voiceprint information to an area of the resource control, a third distance between the first virtual object and the second virtual object when the second voiceprint information is dragged to the area of the resource control; and display, based on the third distance being less than a third distance threshold, a resource page.

In a possible implementation, the second cooperative action is a healing action, and a healing skill control is further displayed in the game picture. The first operation on the second voiceprint information is an operation of dragging the second voiceprint information to an area of the healing skill control.

The providing module is configured to determine, in response to the operation of dragging the second voiceprint information to an area of the healing skill control, a second distance between the first virtual object and the second virtual object when the second voiceprint information is dragged to the area of the healing skill control; and control, based on the second distance being less than a second distance threshold, the first virtual object to cast a healing skill, the healing skill being configured for increasing a hit point of the second virtual object.

In a possible implementation, the providing module is configured to determine, based on the second distance being less than a second distance threshold, a target area according to position information of the first virtual object, the second virtual object being located in the target area; and control the first virtual object to cast the healing skill in the target area.

In a possible implementation, the healing skill is further configured for increasing a hit point of a fifth virtual object located in the target area, and the fifth virtual object and the first virtual object belong to the same game team.

In a possible implementation, the third cooperation request further includes a second multimedia resource, the second multimedia resource being a multimedia resource for the second virtual object to perform the second cooperative action.

The display module 1101 is further configured to display, in response to a second operation on the second voiceprint information, the second multimedia resource.

According to the foregoing apparatus, when the first virtual object needs help, the cooperative function is triggered to display the action identifier of the candidate cooperative action so that the action identifier of the first cooperative action is triggered in the action identifier of the candidate cooperative action, and the first cooperation request including the first voiceprint information of the first cooperative action is transmitted to the second terminal device corresponding to the second virtual object. Thus, the second virtual object timely provides the help needed by the first virtual object for the first virtual object. In this manner, timely and effective communication between two players can be achieved without voice interaction between a player controlling the first virtual object and a player controlling the second virtual object, which enriches communication manners between the two players, thereby improving the flexibility and diversity of game interaction, improving game experience of the players, and further improving a human-computer interaction rate.

FIG. 12 is a schematic structural diagram of another game interaction apparatus according to an embodiment of the present disclosure. As shown in FIG. 12, the apparatus includes:
a receiving module 1201, configured to receive a first cooperation request, the first cooperation request including first voiceprint information, the first voiceprint information being determined based on an action identifier of a first cooperative action, and the first cooperation request being configured for providing cooperation content corresponding to the first cooperative action for a first virtual object; and
a providing module 1202, configured to provide, based on the first voiceprint information, cooperation content corresponding to the first cooperative action for the first virtual object.

In a possible implementation, the apparatus further includes:
a display module, configured to display the first voiceprint information; and
a providing module 1202, configured to provide, in response to a first operation on the first voiceprint information, cooperation content corresponding to the first cooperative action for the first virtual object.

In a possible implementation, the first cooperative action is a resource acquisition action, and the first operation on the first voiceprint information is an operation of dragging the first voiceprint information to an area of the resource control in the game picture; and alternatively,

The first cooperative action is a healing action, and the first operation on the first voiceprint information is an operation of dragging the first voiceprint information to an area of the healing skill control in the game picture.

In a possible implementation, the first cooperation request further includes a first multimedia resource, the first multimedia resource being a multimedia resource for the first virtual object to perform the first cooperative action.

The display module is further configured to display, in response to a second operation on the first voiceprint information, the first multimedia resource.

In a possible implementation, the apparatus further includes:
a transmitting module, configured to transmit a third cooperation request to the first terminal device, the third cooperation request including second voiceprint information of the second cooperative action, and the third cooperation request being configured for providing cooperation content corresponding to the second cooperative action for the second virtual object by the first terminal device.

When the apparatus provided above implements the functions of the apparatus, only division into the foregoing function modules is used as an example for description. In the practical application, the functions may be allocated to and completed by different function modules according to requirements. That is, an internal structure of the device is divided into different function modules, to complete all or some of the functions described above. In addition, the apparatus and method embodiments provided in the foregoing embodiments belong to the same conception. For the specific implementation process, refer to the method embodiments. Details are not described herein again.

FIG. 13 is a schematic structural diagram of a game interaction system according to an embodiment of the present disclosure. As shown in FIG. 13, the system 1300 includes a first terminal device 1301 and a second terminal device 1302. The first terminal device 1301 is configured to execute the embodiment shown in FIG. 2, and the second terminal device 1302 is configured to execute the embodiment shown in FIG. 9.

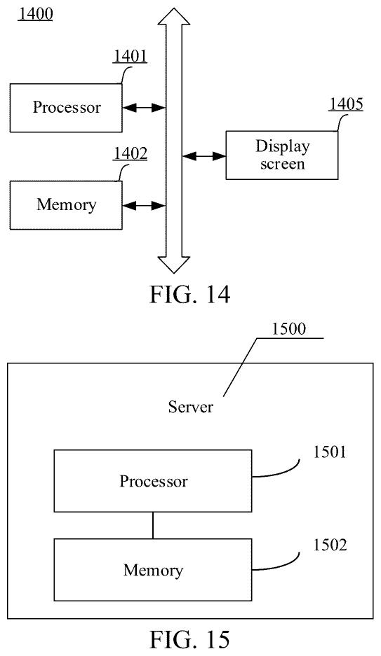

FIG. 14 is a structural block diagram of a terminal device 1400 according to an exemplary embodiment of the present disclosure. The terminal device 1100 may be respectively any electronic device product that may perform human-computer interaction with a user in one or more manners such as a keyboard, a touchpad, a remote control, voice interaction, or a handwriting device. For example, a PC, a mobile phone, a smartphone, a PDA, a wearable device, a PPC, a tablet computer, a smart on-board unit, a smart television, a smart speaker, or a smartwatch.

Generally, the terminal device 1400 includes a processor 1401 and a memory 1402.

The processor 1401 may include one or more processing cores, for example, a 4-core processor or an 8-core processor. The processor 1401 may be implemented in at least one hardware form of a digital signal processor (DSP), a field-programmable gate array (FPGA), or a programmable logic array (PLA). The processor 1401 may alternatively include a main processor and a coprocessor. The main processor is a processor configured to process data in an awake state, and is also referred to as a central processing unit (CPU). The coprocessor is a low power consumption processor configured to process the data in a standby state. In some embodiments, the processor 1401 may have a graphics processing unit (GPU) integrated therein. The GPU is configured to render and draw content that needs to be displayed on a display screen. In some embodiments, the processor 1401 may further include an artificial intelligence (AI) processor. The AI processor is configured to process computing operations related to machine learning.

The memory 1402 may include one or more computer-readable storage media. The computer-readable storage media may be non-transient. The memory 1402 may alternatively include a high-speed random access memory, as well as non-volatile memory, such as one or more disk storage devices and flash storage devices. In some embodiments, the non-transitory computer-readable storage medium in the memory 1402 is configured to store at least one instruction. The at least one instruction is configured for being executed by the processor 1401 to implement the game interaction method provided in the method embodiments of the present disclosure.

In some embodiments, the terminal device 1400 may alternatively include: a display screen 1405.

The display screen 1405 is configured to display a user interface (UI). The UI may include a graph, text, an icon, a video, and any combination thereof. When the display screen 1405 is a touch display screen, the display screen 1405 further has a capability of acquiring a touch signal on or above a surface of the display screen 1405. The touch signal may be input to the processor 1401 as a control signal for processing. In this case, the display screen 1405 may be further configured to provide a virtual button and/or a virtual keyboard, also referred to as a soft button and/or a soft keyboard. In some embodiments, the display screen 1405 may be one, set on a front panel of the terminal device 1400; In some other embodiments, the display screen 1405 may be at least two, respectively arranged on different surfaces of the terminal device 1400 or in a folded design; In some other embodiments, the display screen 1405 may be a flexible display screen, arranged on a curved surface or a folded surface of the terminal device 1400. Alternatively, the display screen 1405 may be even arranged in a non-rectangular irregular pattern, namely, a special-shaped screen. The display screen 1405 may be prepared using a material such as a liquid crystal display (LCD), an organic light-emitting diode (OLED), or the like.

A person skilled in the art may understand that the structure shown in FIG. 14 constitutes no limitation on the terminal device 1400, and the terminal device 1400 may include more or fewer components than those shown in the figure, or a combination of some components, or have a different arrangement of components.

FIG. 15 is a schematic structural diagram of a server according to an embodiment of the present disclosure. The server 1500 may vary a lot due to different configurations or performance, and may include one or more CPUs 1501 and one or more memories 1502. The one or more memories 1502 store at least one program code, and the at least one program code is loaded and executed by the one or more CPUs 1501 to implement the game interaction method provided in the foregoing method embodiments. Certainly, the server 1500 may further have assemblies such as a wired or wireless network interface, a keyboard, and an I/O interface for inputting and outputting. The server 1500 may further include other assemblies configured to implement device functions, and details are not described herein.

In an exemplary embodiment, a non-volatile computer-readable storage medium is further provided, the non-volatile computer-readable storage medium stores at least one program code, and the at least one program code is loaded and executed by a processor, to cause a computer to implement any one of the foregoing the game interaction methods.

In one embodiment, the foregoing computer-readable storage medium may be a read-only memory (ROM), a random access memory (RAM), a compact disc read-only memory (CD-ROM), a magnetic tape, a floppy disk, an optical data storage device, or the like.

In an exemplary embodiment, a computer program or a computer program product is further provided, the computer program or the computer program product stores at least one computer instruction, and the at least one computer instruction is loaded and executed by a processor, to cause a computer to implement any one of the foregoing the game interaction methods.

Information (including but not limited to user equipment information, user personal information, and the like), data (including but not limited to data for analysis, data for storage, data for display, and the like), and signals involved in the present disclosure are all authorized by users or fully authorized by all parties, and collection, use, and processing of related data need to comply with related laws, regulations, and standards of related countries and regions. For example, the game pictures, action identifiers and voiceprint information involved in the present disclosure is acquired under full authorization.

“Multiple” mentioned in this specification means two or more. “And/or” describes an association relationship for describing associated objects and represents that three relationships may exist. For example, A and/or B may represent the following three cases: Only A exists, both A and B exist, and only B exists. The character “/” generally indicates an “or” relationship between the associated objects.

The foregoing descriptions are merely exemplary embodiments of the present disclosure, but are not intended to limit the present disclosure. Any modification, equivalent replacement, or improvement made within the principle of the present disclosure shall fall within the protection scope of the present disclosure.

What is claimed is:

1. A game interaction method, performed by a first terminal device, comprising:
displaying a game picture, the game picture comprising a first virtual object and a second virtual object located in a virtual environment;
displaying, in response to a trigger operation of a cooperative function, action identifiers of at least one candidate cooperative action; and
transmitting, in response to a trigger operation on an action identifier of a first cooperative action among the at least one candidate cooperative action, a first cooperation request to a second terminal device corresponding to the second virtual object, the first cooperation request comprising a first voiceprint information, the first cooperation request being configured for providing cooperation content corresponding to the first cooperative action for the first virtual object by the second terminal device based on the first voiceprint information, and the first voiceprint information being determined based on the action identifier of the first cooperative action.

2. The method according to claim 1, wherein transmitting, in response to the trigger operation on an action identifier of the first cooperative action among the at least one candidate cooperative action, the first cooperation request to the second terminal device corresponding to the second virtual object comprises:
determining, in response to the trigger operation on the action identifier of the first cooperative action among the at least one candidate cooperative action, a first distance between the first virtual object and the second virtual object; and
transmitting, based on the first distance being less than a first distance threshold, the first cooperation request to the second terminal device.

3. The method according to claim 1, wherein transmitting, in response to the trigger operation on an action identifier of the first cooperative action among the at least one candidate cooperative action, the first cooperation request comprising first voiceprint information to a second terminal device corresponding to the second virtual object comprises:
transmitting, in response to the trigger operation on the action identifier of the first cooperative action, a second cooperation request comprising the action identifier of the first cooperative action to a server, the second cooperation request being configured for transmitting the first cooperation request comprising the first voiceprint information to the second terminal device by the server.

4. The method according to claim 1, wherein the second virtual object and the first virtual object belong to a same game team, and at least one third virtual object is further displayed in the game picture; and the method further comprises:
determining, in response to a trigger operation of a cooperative object determining function, at least one reference virtual object among the at least one third virtual object, the at least one reference virtual object and the first virtual object belonging to the same game team;
determining distances corresponding to reference virtual objects and a distance corresponding to the second virtual object, a distance corresponding to the reference virtual object of distances corresponding to reference virtual objects being a distance between the reference virtual object and the first virtual object when the cooperative object determining function is triggered, and the distance corresponding to the second virtual object being a distance between the second virtual object and the first virtual object when the cooperative object determining function is triggered;
displaying, based on the distance corresponding to the second virtual object being less than the distances corresponding to the reference virtual objects, a lock identifier at a target position of the second virtual object, the lock identifier being configured for indicating that the second virtual object is used as a cooperative object of the first virtual object; and
establishing, in response to a trigger operation of a cooperative relationship establishing function, a cooperative relationship between the first virtual object and the second virtual object.

5. The method according to claim 4, wherein establishing, in response to the trigger operation of the cooperative relationship establishing function, the cooperative relationship between the first virtual object and the second virtual object comprises:
transmitting, in response to the trigger operation of the cooperative relationship establishing function, a cooperative relationship establishing request to the second terminal device; and
establishing, in response to information of accepting the cooperative relationship establishing request returned by the second terminal device, the cooperative relationship between the first virtual object and the second virtual object, wherein the cooperative relationship establishing request comprises an object identifier of the first virtual object and an object identifier of the second virtual object and the cooperative relationship establishing request is configured for indicating that the first virtual object requests to establish the cooperative relationship with the second virtual object.

6. The method according to claim 4, wherein after displaying the lock identifier at the target position of the second virtual object, the method further comprises:
displaying, in response to a trigger operation on a fourth virtual object, the lock identifier at a target position of the fourth virtual object, and canceling display of the lock identifier at the target position of the second virtual object, the fourth virtual object being any virtual object among the at least one third virtual object, wherein the at least one third virtual object and the first virtual object belong to the same game team; and
establishing, in response to the trigger operation of the cooperative relationship establishing function, a cooperative relationship between the first virtual object and the fourth virtual object.

7. The method according to claim 1, further comprising:
controlling, in response to the trigger operation on the action identifier of the first cooperative action among the at least one candidate cooperative action, the first virtual object to perform the first cooperative action.

8. The method according to claim 7, wherein the first cooperation request further comprises a first multimedia resource, the first multimedia resource being a multimedia resource for the first virtual object to perform the first cooperative action.

9. The method according to claim 1, further comprising:
receiving a third cooperation request, the third cooperation request comprising second voiceprint information of a second cooperative action and being configured for providing cooperation content corresponding to the second cooperative action for the second virtual object; and
providing the cooperation content corresponding to the second cooperative action for the second virtual object based on the second voiceprint information.

10. The method according to claim 9, wherein providing the cooperation content corresponding to the second cooperative action for the second virtual object based on the second voiceprint information comprises:
displaying the second voiceprint information; and
providing, in response to a first operation on the second voiceprint information, the cooperation content corresponding to the second cooperative action for the second virtual object.

11. The method according to claim 10, wherein the second cooperative action is a resource acquisition action, a resource control is further displayed in the game picture, and the first operation on the second voiceprint information is an operation of dragging the second voiceprint information to an area of the resource control; and
wherein providing, in response to the first operation on the second voiceprint information, the cooperation content corresponding to the second cooperative action for the second virtual object comprises:
displaying a resource page in response to the operation of dragging the second voiceprint information to the area of the resource control, resource information of at least one type of resource being displayed in the resource page, and the at least one type of resource being a resource already possessed by the first virtual object; and
transferring, in response to a trigger operation on resource information of target resources among the at least one type of resource, the target resources to the second virtual object.

12. The method according to claim 11, wherein transferring, in response to the trigger operation on resource information of target resources among the at least one type of resource, the target resources to the second virtual object comprises:
displaying, in response to the trigger operation on the resource information of the target resources among the at least one type of resource, a quantity determining box, the quantity determining box being configured for determining a target quantity of the target resources transferred to the second virtual object; and
acquiring the target quantity based on the quantity determining box, and transferring the target resources of the target quantity to the second virtual object.

13. The method according to claim 11, wherein displaying the resource page in response to the operation of dragging the second voiceprint information to the area of the resource control comprises:
determining, in response to the operation of dragging the second voiceprint information to the area of the resource control, a third distance between the first virtual object and the second virtual object when the second voiceprint information is dragged to the area of the resource control; and
displaying, based on the third distance being less than a third distance threshold, the resource page.

14. The method according to claim 10, wherein the second cooperative action is a healing action, and a healing skill control is further displayed in the game picture; and the first operation on the second voiceprint information is an operation of dragging the second voiceprint information to an area of the healing skill control; and
wherein providing, in response to the first operation on the second voiceprint information, the cooperation content corresponding to the second cooperative action for the second virtual object comprises:
determining, in response to the operation of dragging the second voiceprint information to the area of the healing skill control, a second distance between the first virtual object and the second virtual object when the second voiceprint information is dragged to the area of the healing skill control; and
controlling, based on the second distance being less than a second distance threshold, the first virtual object to cast a healing skill, the healing skill being configured for increasing a hit point of the second virtual object.

15. The method according to claim 14, wherein controlling, based on the second distance being less than the second distance threshold, the first virtual object to cast the healing skill comprises:
determining, based on the second distance being less than the second distance threshold, a target area according to a position information of the first virtual object, the second virtual object being located in the target area; and
controlling the first virtual object to cast the healing skill in the target area.

16. The method according to claim 15, wherein the healing skill is further configured for increasing a hit point of a fifth virtual object located in the target area, and the fifth virtual object and the first virtual object belong to a same game team.

17. The method according to claim 9, wherein the third cooperation request further comprises a second multimedia resource, the second multimedia resource being a multimedia resource for the second virtual object to perform the second cooperative action; and the method further comprises:
displaying, in response to a second operation on the second voiceprint information, the second multimedia resource.

18. A game interaction method, performed by a second terminal device, comprising:
receiving a first cooperation request, the first cooperation request comprising first voiceprint information, the first voiceprint information being determined based on an action identifier of a first cooperative action, and the first cooperation request being configured for providing cooperation content corresponding to the first cooperative action for a first virtual object; and
providing the cooperation content corresponding to the first cooperative action for the first virtual object based on the first voiceprint information.

19. A game interaction apparatus, comprising a memory for storing instructions and a processor for executing the instructions to:
display a game picture, the game picture comprising a first virtual object and a second virtual object located in a virtual environment;
display, in response to a trigger operation of a cooperative function, action identifiers of at least one candidate cooperative action; and
transmit, in response to a trigger operation on an action identifier of a first cooperative action among the at least one candidate cooperative action, a first cooperation request to a second terminal device corresponding to the second virtual object, the first cooperation request comprising a first voiceprint information, the first cooperation request being configured for providing cooperation content corresponding to the first cooperative action for the first virtual object by the second terminal device based on the first voiceprint information, and the first voiceprint information being determined based on the action identifier of the first cooperative action.

20. A non-transitory computer readable medium storing a plurality of instructions, wherein the plurality of instructions, when executed by a processor, configure the processor to perform the operations in the method according to claim 1.
